(19) United States
(12) Patent Application Publication
(10) Pub. No.: US 2026/0204845 A1
(43) Pub. Date: Jul. 16, 2026

(54) DEVICE FOR PROTECTING AGAINST PARTIAL DISCHARGES

(71) Applicant: SOURIAU, VERSAILLES CEDEX (FR)

(72) Inventors: Stéphane BARLERIN, FATINES (FR); Somya ANAND, LEMANS (FR)

(21) Appl. No.: 19/445,993

(22) Filed: Jan. 12, 2026

(30) Foreign Application Priority Data
Jan. 13, 2025 (FR) 2500340

(51) Int. Cl. H01R 13/648

(52) U.S. Cl. CPC H01R 13/6485

(57) ABSTRACT

A device to protect against partial discharges. The device includes a male connector and a female connector. The male and female connectors include a male housing, a female housing, at least one first insulator of the male housing and at least one first insulator of the female housing. A portion of the first insulator of the female housing is inside the male housing. Each insulator includes a through hole, the through hole being configured to allow a male contact and a female contact to pass. A portion of the male contact is inside the female contact. A first electrical conductor is positioned inside the male contact, and a second electrical conductor is positioned inside the female contact. An insulating layer is positioned on the periphery of the male contact and the female contact.

### TECHNICAL FIELD OF THE INVENTION

The present invention relates to a device for protecting against partial discharges. It applies in particular to the field of electrical insulation and connectivity.

### PRIOR ART

CO2 emission restrictions are driving industries using thermal engines to switch to electric engines, in particular in aeronautics. The electrification of aircraft involves modifying the current electrical distribution system, in the kilowatt range, to a distribution system making it possible to supply the quantity of energy required for the operation of electric engines for propulsion, in the megawatt range. The increase in power is achieved by an increase in electrical voltage, rather than by an increase in current, which would involve an increase in the cross-sections of the electrical conductors, therefore an increase in weight, undesired in the aeronautics industry.

Increasing the voltage is not achieved without difficulties. An increase in voltage can cause an increase in operating faults linked with the appearance of electric arcs, and in particular linked with partial discharges at altitude.

Assembling a connector component with insulation requires functional clearances between the parts. This results in air layers between the parts. From an electric field value in the air zone, partial discharges appear in these air layers and these discharges lead to a degradation of the insulation and then a premature breakdown thereof.

Partial discharges occur primarily in critical zones, where air gaps due to assembly clearances between dielectric parts and metal parts are small in thickness relative to the thickness of the dielectric parts.

At altitude, the pressure is reduced, which facilitates the appearance of partial discharges in air zones subjected to an electric field. The voltage strength of the insulation is therefore reduced at altitude according to Paschen's law.

For example, FIG. 1 shows an application of a prior art of a device for protecting against partial discharges. However, this device has drawbacks which do not make it possible to completely avoid partial discharges in a connector.

This device incorporates several essential components, such as a male housing connected to the ground, a female housing, high-voltage conductors and insulators. Despite its design aimed at limiting undesirable electrical phenomena, this device has technical limitations which do not make it possible to completely avoid partial discharges.

In particular, critical zones remain at metal-air-dielectric interfaces, where high electric fields can cause electric arcs. These weak points are particularly located at the interface between cables and contacts, between metal and insulating parts, as well as at the junction of male and female contacts once coupled. These configurations generate triple points and air gaps subjected to a high electric field and in contact with bare metal parts. These are the main sources of the appearance of partial discharges.

Some protective techniques, such as adding seals or electric bonding of the dielectric surfaces, remain insufficient to remove the risks of partial discharges. These limitations justify the need for innovative solutions to improve the voltage strength and reliability of connectors in high-voltage environments, particularly in aeronautics.

### DISCLOSURE OF THE INVENTION

The present invention aims to overcome these drawbacks with a totally innovative approach.

More specifically, the aim of the invention is to provide a device for protecting against partial discharges.

An objective of the invention is to provide such a device, which can be easily adapted to existing systems.

These objectives, as well as others that will appear later, are achieved, using a device for protecting against partial discharges comprising a male connector and a female connector comprising:
a male housing and a female housing, said male housing comprising a contact surface with said female housing;
at least a first insulator of the male housing positioned inside said male housing and at least a first insulator of the female housing positioned inside said female housing, a portion of said first insulator of the female housing being inserted inside the male housing;
each insulator comprising a through hole, said through hole being configured to allow a male contact and a female contact to pass; a portion of the male contact being inside the female contact;
a first electrical conductor positioned inside the male contact and a second electrical conductor positioned inside the female contact;
remarkable in that an insulating layer is positioned on the periphery of the male contact and the female contact.

The insulating layer is made with an insulating or semi-insulating or semiconductor dielectric material.

Thanks to these arrangements, this device proposes a novel technique for improving the voltage strength of connectors consisting in removing zones where bare metal parts are in contact with air subjected to a voltage or an electric field, both in the case of air gaps and in the case of triple points.

This contact insulation protection device makes it possible to limit the appearance of partial discharges by removing air-to-metal interfaces in air zones subjected to an electric field.

The invention is advantageously implemented according to the embodiments and variants set forth below, which are to be considered individually or according to any technically feasible combination.

In one embodiment, the first electrical conductor comprises a circular cylindrical portion having a junction surface with the male contact, and the second electrical conductor comprises a circular cylindrical portion having a junction surface with the female contact.

Thanks to these arrangements, the junction surfaces make it possible to ensure the transition of electricity between the conductors and the contacts.

In one embodiment, a sheath is positioned on the first electrical conductor, said sheath comprises one end having a contact with a portion of the insulating layer of the male contact; another sheath is positioned on the second electrical conductor, said sheath comprises one end having a contact with a portion of the insulating layer of the female contact.

Thanks to these arrangements, the sheath makes it possible to electrically insulate the conductors up to the contacts.

In one embodiment, the sheath is hollow and comprises one end intended to house a portion of the first electrical conductor, the other sheath is hollow and comprises one end intended to house a portion of the second electrical conductor, another portion of the first electrical conductor extends beyond the end of the sheath and another portion of the second electrical conductor extends beyond the end of the other sheath.

In one embodiment, at least one of the following elements comprises a groove: the first insulator of the male housing, the first insulator of the female housing; each groove comprises a seal.

Thanks to these arrangements, the seals make it possible to ensure the tightness of the device and cut off electrical leakage lines.

In one embodiment, a portion of the insulating layer is positioned inside the male contact and the female contact.

Thanks to these arrangements, this insulating layer portion limits partial discharges located at this location of the device.

In one embodiment, another insulating layer is positioned on an inner surface of the male housing and on an inner surface of the female housing.

Thanks to these arrangements, this other insulating layer makes it possible to limit the creation of partial discharges around the housings.

In one embodiment, a tube is disposed on one of the ends of the male contact; this end of the male contact being joined with the first insulator of the male housing.

In one variant, an insulating layer is positioned on the periphery of said tube and a portion of the insulating layer is positioned inside said tube.

Thanks to these arrangements, the tube associated with the insulating layer provides protection against partial discharges on a non-insulated zone of the male contact.

In one embodiment, a second portion of the housing is in contact with a transverse surface of the male housing, another second portion of the housing being in contact with a transverse surface of the female housing.

### BRIEF DESCRIPTION OF THE FIGURES

Other advantages, aims and features of the present invention will come out from the following description made, for an explanatory and non-limiting purpose, with reference to the appended drawings, wherein:

FIG. 1 (relating to the prior art) shows a sectional view of a device for protecting against partial discharges;

FIG. 2 shows a sectional view of a representation of a device for protecting against partial discharges according to an object of the present invention;

FIG. 3 shows a perspective view of a diagram showing the insulating layer on the contacts;

FIG. 4 shows a profile view of a variant showing a portion of the device;

FIG. 5 shows a sectional view of the contacts with the insulating layer;

FIG. 6 shows a sectional view of a diagram of a variant of the male contact.

### DESCRIPTION OF THE EMBODIMENTS

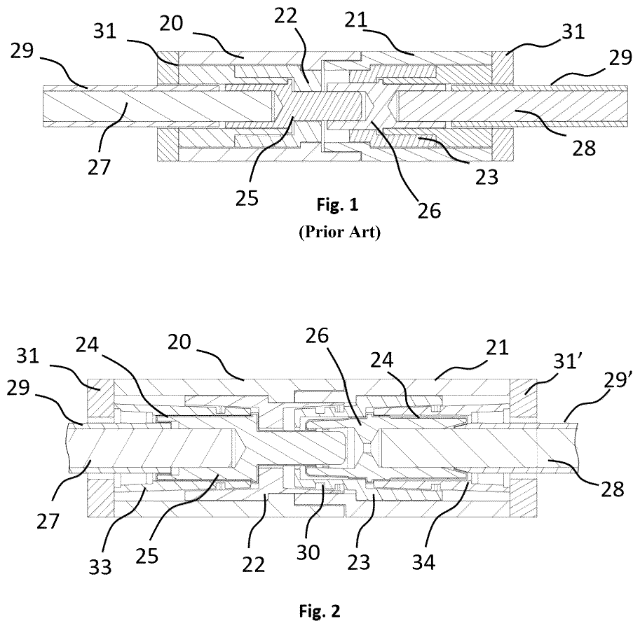

FIG. 1 shows a diagram of the prior art of a device for protecting against partial discharges.

The description of this figure has already been given in the prior art.

FIG. 2 shows a diagram representing a novel device for protecting against partial discharges.

The device is housed in a male connector and a female connector.

This diagram shows components of the device.

The components are the following elements: a male housing 20, a female housing 21, a male contact 25, a female contact 26, and an insulating layer 24.

According to one embodiment, the male housing 20 and the female housing 21 comprise a cylindrical shape. They make it possible to ensure the protection of each component.

According to one variant, the male housing 20 and the female housing 21 are metallic or made of metallized plastic, and connected to the electrical ground.

A portion of the shape of the male housing 20 molds a portion of the shape of the female housing 21 forming a shell.

The male housing 20 and the female housing 21 comprise a through hole. This through hole makes it possible to insert all the other components of the device inside the male housing 20 and the female housing 21.

A first insulator of the male housing 22 and a first insulator of the female housing 23 are housed inside the through hole.

The first insulator of the male housing 22 comprises a contact surface with the male housing 20.

A portion of the first insulator of the male housing 22 is inside the female housing 21.

The first insulator of the male housing 22 is interlocked with the female housing 21.

The first insulator of the female housing 23 comprises a contact surface with the female housing 21.

According to one exemplary embodiment, the first insulator of the male housing 22 and the first insulator of the female housing 23 comprise a through hole where the male contact 25 and the female contact 26 are housed.

A portion of the male contact 25 is inside the female contact 26.

An insulating layer 24 is positioned between the male contact 25 and the first insulator of the male housing 22, between the female contact 26 and the first insulator of the female housing 23.

The insulating layer 24 runs along the outer surfaces of the male contact 25 and the female contact 26.

A portion of the insulating layer 24 runs along a portion of the inner surface of the male contact 25 and the female contact 26.

The insulating layer 24 is represented as a black line in the figure.

The term partial discharge represents an electrical breakdown in an air layer. The air layer in question relates to functional clearances between the male housing 20, the female housing 21 and the insulators of the device.

The insulating layer 24 may be in the form of one of the following elements: a varnish, a paint, a polymer, an elastomer, a material that can be deposited on metal contacts.

Adding the insulating layer is carried out using one of the following techniques: by brush, by roller, by spraying, by dipping, by overmolding.

Depending on the environment of the device, the clearances are filled with fluid, such as air or another gas.

A portion of the insulating layer 24 of the male contact 25 runs along a portion of a sheath 29. This portion of the sheath 29 is inserted into the male contact 25.

A portion of the insulating layer 24 of the female contact 26 runs along a portion of another sheath 29′. This portion of the sheath 29′ is inserted into the female contact 26.

The sheath 29 is hollow and comprises one end intended to house a portion of the first electrical conductor, the other sheath 29′ is hollow and comprises one end intended to house a portion of the second electrical conductor 28.

Another portion of the first electrical conductor 27 extends beyond the end of the sheath 29 and another portion of the second electrical conductor 28 extends beyond the end of the other sheath 29′.

The sheath 29 makes it possible to electrically insulate the conductors.

The first electrical conductor 27 comprises a circular cylindrical portion having a junction surface with the male contact 25.

The second electrical conductor 28 comprises a circular cylindrical portion having a junction surface with the female contact 26.

Depending on the type of contact, one of the ends of the sheath 29 is stripped in a straight or beveled manner.

A second portion of the housing 31 is in contact with a transverse surface of the male housing 20.

The second portion of the housing closes the whole. Another second portion of the housing 31′ being in contact with a transverse surface of the female housing 21.

According to one exemplary embodiment, one of the following elements comprises a groove: the first insulator of the male housing 22, the first insulator of the female housing 23; each groove comprises a seal 30. They make it possible to cut off leakage lines between the contacts and the housings.

According to one exemplary embodiment, the assembly of the components of the device is carried out by crimping.

Crimping corresponds to an assembly of two parts by deformation.

A second insulator of the male housing 33 and a second insulator of the female housing 34 are housed inside the through hole.

The second insulator of the male housing 33 is positioned between the male contact 25 and the first insulator of the male housing 22.

The second insulator of the female housing 34 is positioned between the female contact 26 and the first insulator of the female housing 23.

Naturally, the invention is described in the foregoing by way of example. It is understood that a person skilled in the art is able to implement various variant embodiments of the invention without however departing from the scope of the invention.

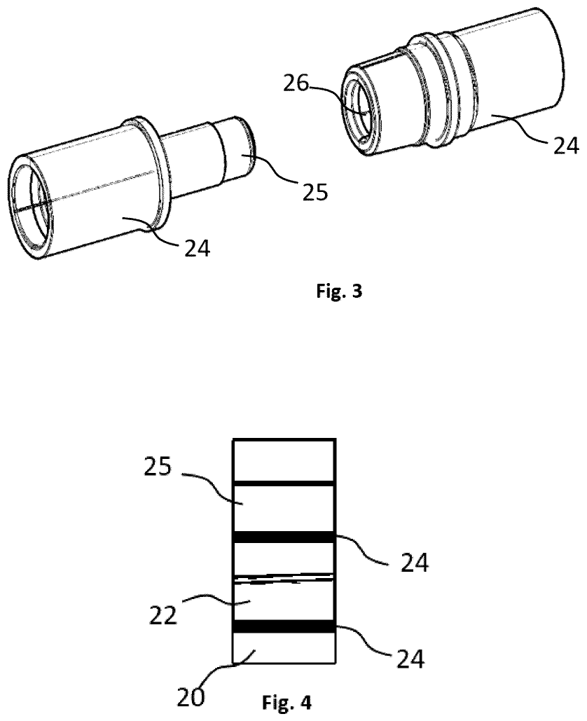

FIG. 3 shows a diagram showing the insulating layer 24 on the contacts.

This diagram is shown in perspective.

This figure illustrates the same features as the previous figure.

The male contact 25 comprises a surface without an insulating layer 24. This surface without an insulating layer 24 will be inserted into the housing of the female contact 26.

FIG. 4 shows one variant showing a portion of the device.

This diagram illustrates the same features as FIG. 2.

This variant of the device comprises an insulating layer 24 running along an inner surface of the male housing 20 and an inner surface of the female housing 21.

The insulating layer 24 and the first insulator of the male housing 22 or the first insulator of the female housing 23 are separated by a clearance comprising a fluid.

According to this example, the insulating layer 24 runs along the male housing 20, the first insulator of the male housing 22, and the male contact 25.

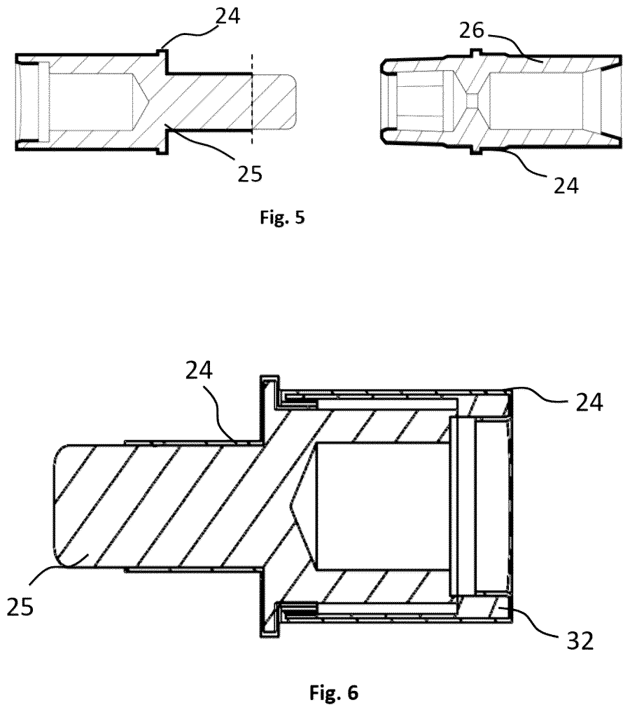

FIG. 5 shows a sectional view of the contacts with the insulating layer 24. This sectional view illustrates the same features as FIG. 2.

This exemplary embodiment shows the portion of the male contact 25 that goes inside the female contact 26.

The vertical line illustrated in this figure corresponds to the end of the insulating layer 24 on the male contact 25.

FIG. 6 shows a diagram of a variant of the male contact 25.

The male contact 25 comprises a conductive tube 32 positioned on one of its ends.

The tube 32 is covered with an insulating layer 24 on its outer surface and on a portion of its inner surface.

The tube 32 is assembled with the male contact 25 after crimping the male contact 25 with the cable. This makes it possible to ensure electrical contact between the tube 32 and the male contact 25.

It is emphasized that all features, as they arise for a person skilled in the art from the present description, the attached drawings and features, even if concretely they have only been described in relation to other determined features, both individually and in any combinations, can be combined with other features or groups of features disclosed herein, insofar as this has not been expressly excluded or technical circumstances make such combinations impossible or meaningless.

### LIST OF REFERENCE SIGNS

TABLE 1

| References | Designations |
|---|---|
| 20 | Male housing |
| 21 | Female housing |
| 22 | First insulator of male housing |
| 23 | First insulator of female housing |
| 24 | Insulating layer |
| 25 | Male contact |
| 26 | Female contact |
| 27 | First electrical conductor |
| 28 | Second electrical conductor |
| 29 | Sheath |
| 30 | Seal |
| 31 | Second portion of housing |
| 32 | Tube |
| 33 | Second insulator of male housing |
| 34 | Second insulator of female housing |

1-9. (canceled)

10. A device for protecting against partial discharges comprising a male connector and a female connector, the male connector and the female connector comprising:
a housing, a first portion of the housing comprising a male housing and a female housing, the male housing comprising a contact surface with the female housing;
at least one first insulator of the male housing positioned inside the male housing and at least one first insulator of the female housing positioned inside the female housing, a portion of said at least one first insulator of the female housing being inserted inside the male housing;
each insulator comprising a through hole, the through hole being configured to allow a male contact and a female contact to pass, a portion of the male contact being inside the female contact;
a first electrical conductor positioned inside the male contact and a second electrical conductor positioned inside the female contact; and
an insulating layer is positioned on a periphery of the male contact and the female contact.

11. The device of claim 10, wherein the first electrical conductor comprises a circular cylindrical portion having a junction surface with the male contact; and wherein the second electrical conductor comprises a circular cylindrical portion having a junction surface with the female contact.

12. The device of claim 10, further comprising a first sheath positioned on the first electrical conductor, the first sheath comprises a first end having a contact with a portion of the insulating layer positioned on the periphery of the male contact; and a second sheath positioned on the second electrical conductor, the second sheath comprises a first end having a contact with a portion of the insulating layer positioned on the periphery of the female contact.

13. The device of claim 12, wherein the first sheath is hollow and comprises a second end configured to house a portion of the first electrical conductor; wherein the second sheath is hollow and comprises a second end configured to house a portion of the second electrical conductor; wherein another portion of the first electrical conductor extends beyond the second end of the first sheath; and wherein another portion of the second electrical conductor extends beyond the second end of the second sheath.

14. The device of claim 12, wherein at least one of the following comprises a groove:
said at least one first insulator of the male housing, said at least one first insulator of the female housing, and the first sheath; and wherein each groove comprises a seal.

15. The device of claim 10, wherein a portion of the insulating layer is positioned inside the male contact and the female contact.

16. The device of claim 10, further comprising another insulating layer positioned on an inner surface of the male housing and on an inner surface of the female housing.

17. The device of claim 10, further comprising a tube disposed on a first end of the male contact; the first end of the male contact being joined with said at least one first insulator of the male housing.

18. The device of claim 10, wherein a second portion of the housing is in contact with a transverse surface of the male housing and in contact with a transverse surface of the female housing.
